(19) United States
(12) Patent Application Publication
(10) Pub. No.: US 2012/0289151 A1
(43) Pub. Date: Nov. 15, 2012

(54) Method of Handling Attach Procedure and Related Communication Device

(76) Inventor: Chih-Hsiang Wu, Taoyuan County (TW)

(21) Appl. No.: 13/466,066

(22) Filed: May 7, 2012

Related U.S. Application Data
(60) Provisional application No. 61/483,758, filed on May 9, 2011.

(51) Int. Cl. H04W 48/20

(52) U.S. Cl. 455/39

(57) ABSTRACT

A method of handling attach procedure for a mobile device in a wireless communication system is disclosed. The method comprises performing an attach procedure to a network of the wireless communication system, receiving an attach reject message of the attach procedure including a reject reason associated to an access point name (APN) setting of the mobile device, from the network, and displaying a notification message in response to the received attach reject message.

### CROSS REFERENCE TO RELATED APPLICATIONS

This application claims the benefit of U.S. Provisional Application No. 61/483,758, filed on May 9, 2011 and entitled “Method and Apparatus for a mobile device to attach in a wireless communication system,” the contents of which are incorporated herein in their entirety.

### BACKGROUND OF THE INVENTION

1. Field of the Invention

The application relates to a method utilized in a wireless communication and a communication device thereof, and more particularly, to a method of handling attach procedure in a wireless communication system and a related communication device.

2. Description of the Prior Art

In contrast to the circuit switched model of previous cellular systems (e.g. general packet radio service (GPRS), or universal mobile telecommunications system (UMTS)), LTE system has been designed to support only packet switched (PS) services. It aims to provide seamless Internet Protocol (IP) connectivity between a user equipment (UE) and a packet data network (PDN) via an evolved packet system (EPS) bearer for accessing Internet, as well as for running services such as Voice over IP (VoIP) provided by IP Multimedia Subsystem (IMS). The PDN is responsible for IP address allocation to the UE. An EPS bearer is typically associated with a QoS. Multiple EPS bearers can be established for a user in order to provide different QoS streams or connectivity to different PDNs. For example, a UE can be engaged in a VoIP call while at the same time browsing a web page or downloading a file transfer protocol (FTP) file.

In the LTE system, an UE performs an attach procedure for EPS services. When the UE initiates an attach procedure for a service (i.e. originating call), the UE shall indicate “EPS attach” in the EPS attach type IE. In state EMM-DEREGISTERED, the UE initiates the attach procedure by sending an ATTACH REQUEST message to a mobility management entity (MME), and enters state EMM-REGISTERED-INITIATED. If a valid non access stratum (NAS) security context exists, the UE shall integrity protect the ATTACH REQUEST message combined with the PDN CONNECTIVITY REQUEST message.

In addition, an access point name (APN) is used in the LTE system for a PDN connection. More specifically, the APN is used for identifying a PDN. Therefore, the MME determines whether to accept or reject the PDN CONNECTIVITY REQUEST based on the APN setting. For example, the UE sets the PDN type IE in the PDN CONNECTIVITY REQUEST based on APN setting. The MME may reject the PDN CONNECTIVITY REQUEST if the APN setting of the UE is wrong or unknown by the MME, and thereby responses the UE of an ATTACH REJECT message.

Consider a scenario that a UE supporting LTE and legacy network (e.g. UMTS, GSM or CDMA 2000) may not be able to attach to the LTE network due to wrong APN setting (i.e. APN name is changed or an user of the UE change the APN setting). The wrong APN setting makes the core network rejects the PDN CONNECTIVITY REQUEST in the ATTACH REQUEST message and subsequently makes the attach procedure failed (i.e. the core network responses with ATTACH REJECT message to the UE). The user of the UE cannot know the cause/reason of that the attach procedure is failed. The UE may continuously perform attach procedure, but cannot successfully attach to the LTE network. Thus, the UE cannot obtain services (e.g. originating call, Internet, IMS) from the LTE network.

### SUMMARY OF THE INVENTION

The application discloses a method of handling attach procedure in a wireless communication system and a related communication device in order to solve the abovementioned problems.

The present invention discloses a method of handling attach procedure for a mobile device in a wireless communication system. The method comprises performing an attach procedure to a network of the wireless communication system, receiving an attach reject message of the attach procedure including a reject reason associated to an access point name (APN) setting of the mobile device from the network, and displaying a notification message in response to the received attach reject message.

The present invention discloses a method of handling attach procedure for a mobile device in a wireless communication system. The method comprises performing a first attach procedure to a first radio access technology (RAT), receiving an attach reject message of the first attach procedure including a reject reason associated to an access point name (APN) setting of the mobile device from the network, and perform a second attach procedure to a second RAT after the attach reject message is received.

The present invention discloses a communication device of handling attach procedure for a wireless communication system. The communication device comprises means for performing a first attach procedure to a first radio access technology (RAT), means for receiving an attach reject message of the first attach procedure including a reject reason associated to an access point name (APN) setting of the mobile device from the network, and means for perform a second attach procedure to a second RAT after the attach reject message is received.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system.

FIG. 2 is a schematic diagram of an exemplary communication device according to an embodiment.

FIG. 3 is a flowchart of an exemplary process according to a first embodiment.

FIG. 4 is a flowchart of an exemplary process according to a second embodiment.

### DETAILED DESCRIPTION

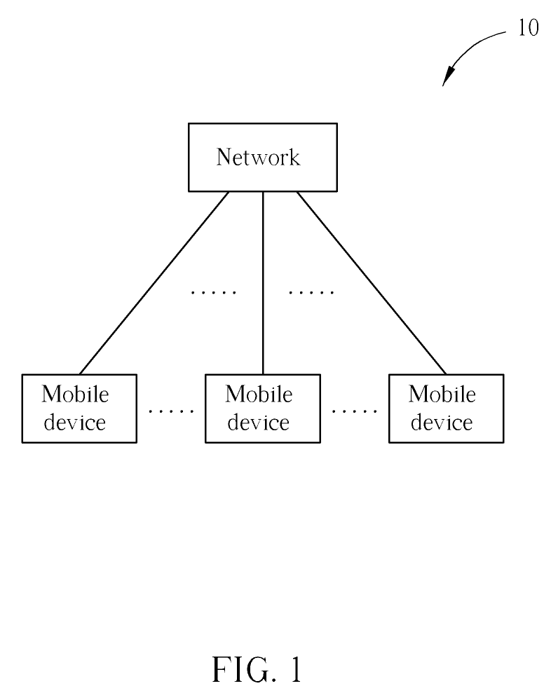

Please refer to FIG. 1, which illustrates a schematic diagram of a wireless communication system 10 according to an embodiment of the present invention. Briefly, the wireless communication system 10 is composed of a network and a plurality of mobile devices. In FIG. 1, the network and the mobile devices are simply utilized for illustrating the structure of the wireless communication system 10. The wireless communication system 10 can be a Global System for Mobile communications (GSM) system, wideband code division multiple access (WCDMA), universal mobile telecommunications system (UMTS), long-term evolution (LTE) system or LTE-Advanced system. In the LTE system, the network can be referred as an Evolved Universal Terrestrial Radio Access Network (E-UTRAN) comprising a plurality of base stations (Node Bs) or a core network (e.g. mobility management entity (MME)), whereas the mobile devices are referred as to user equipments (UEs). Moreover, the UEs can be devices such as mobile phones, computer systems, etc. Besides, the network and the UE can be seen as a transmitter or receiver according to transmission direction, e.g., for uplink (UL), the UE is the transmitter and the network is the receiver, and for downlink (DL), the network is the transmitter and the UE is the receiver.

In the LTE system, before accessing a service (i.e. evolved packet system (EPS) service), the UE needs to perform an attach procedure to the core network (i.e. the MME). Note that, if a valid non access stratum (NAS) security context exists, the UE integrity protects the ATTACH REQUEST message combined with the PDN CONNECTIVITY REQUEST message. A packet data network (PDN) provides services, such as Internet and IMS, to the UE. The PDN connection that the UE wants to establish is based on the access point name (APN) setting. The detailed description can be referred to the prior art, so it not given herein.

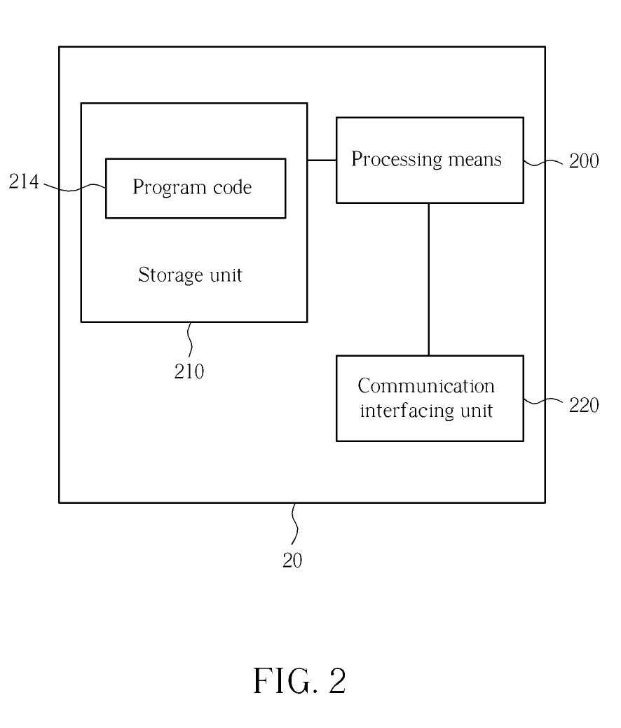

FIG. 2 illustrates a schematic diagram of an exemplary communication device 20. The communication device 20 can be the mobile device shown in FIG. 1, but is not limited herein. The communication device 20 may include a processing means 200 such as a microprocessor or Application Specific Integrated Circuit (ASIC), a storage unit 210 and a communication interfacing unit 220. The storage unit 210 may be any data storage device that can store program code 214, for access by the processing means 200. Examples of the storage unit 210 include but are not limited to a subscriber identity module (SIM), read-only memory (ROM), flash memory, random-access memory (RAM), CD-ROMs, magnetic tape, hard disk, and optical data storage device. The communication interfacing unit 220 is preferably a radio transceiver and can exchange wireless signals with the network according to processing results of the processing means 200.

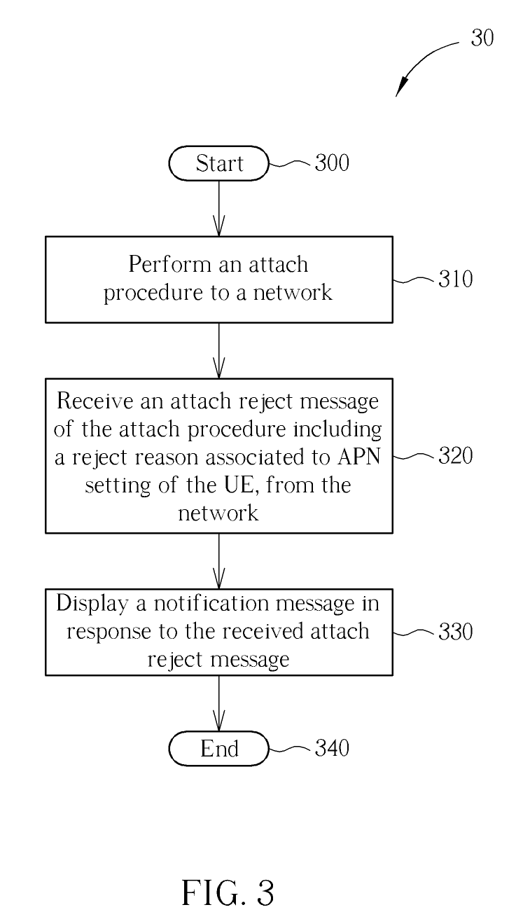

Please refer to FIG. 3, which illustrates a flowchart of an exemplary process 30. The process 30 is utilized in an UE (as the mobile device of FIG. 1) for handling an attach procedure. The process 30 can be compiled into the program code 214 and includes the following steps:

Step 300: Start.

Step 310: Perform an attach procedure to a network.

Step 320: Receive an attach reject message of the attach procedure including a reject reason associated to APN setting of the UE, from the network.

Step 330: Display a notification message in response to the received attach reject message.

Step 340: End.

According to the process 30, an UE supporting LTE and legacy network (e.g. UMTS, GSM or CDMA2000) performs an attach procedure to the LTE network (i.e. the MME). If the UE fails to perform attach to the LTE network due to wrong APN setting (i.e. the UE receives a ATTACH REJECT message with a reject cause indicating unknown APN from the MME), the UE pops out a notification message indicating APN is wrong or unknown by the LTE network on the display. Based on the notification message, the user of the UE can correct the APN setting, so that the UE can attach to the LTE network successfully, to obtain services (e.g. originating call, Internet, IMS, etc) from the LTE network.

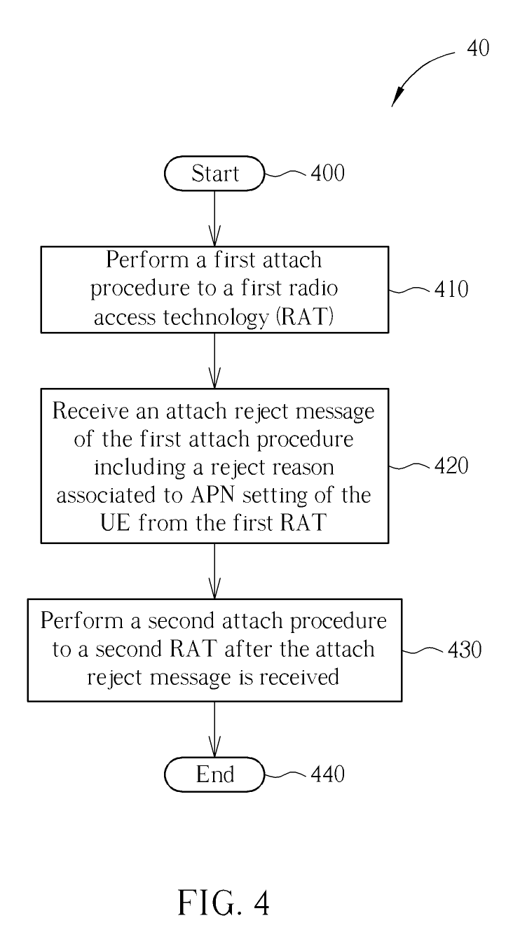

Please refer to FIG. 4, which illustrates a flowchart of a process 40 according to an example of the present application. The process 40 is utilized in an UE (as the mobile device of FIG. 1) for handling an attach procedure. The process 40 can be compiled into the program code 214 and includes the following steps:

Step 400: Start.

Step 410: Perform a first attach procedure to a first radio access technology (RAT).

Step 420: Receive an attach reject message of the first attach procedure including a reject reason associated to APN setting of the UE from the first RAT. [ono] Step 430: Perform a second attach procedure to a second RAT after the attach reject message is received.

Step 440: End.

According to the process 40, if a UE supporting LTE and legacy network (e.g. UMTS, GSM or CDMA2000) fails to perform a first attach procedure to the LTE network e.g. due to wrong APN setting (i.e. the UE receives a ATTACH REJECT message with a reject cause indicating unknown APN from the LTE network), the UE switches to the legacy network to perform a second attach procedure to the legacy network.

Note that, the switch can be done automatically by the UE without user intervention or triggered by user. By performing the second attach procedure to the legacy network, the UE may not be able to acquire PS service (i.e. Internet, and IMS), but is able to make a circuit switch (CS) call. More specifically, in the UMTS system, the UE performs the attach procedure firstly and then perform PDP context activation for packet switch (PS) data access with the APN setting. Therefore, a wrong APN setting or unknown APN may not cause the failure of the second attach procedure, so that the UE can obtain a normal service from the legacy network.

Take an example based on the process 40. If the UE supporting LTE and legacy network (e.g. UMTS) receives the ATTACH REJECT in the LTE network, the UE starts to search a UMTS cell. If the UE finds the UMTS cell, the UE transmits a LOCATION UPDATING REQUEST and ATTACH REQUEST if the UMTS cell belonging to a network operation mode two and the UE supports CS and PS services. If the UMTS cell belonging to a network operation mode one and the UE supports CS and PS services, the UE only transmits the ATTACH REQUEST indicating combined attach. If the UE only supports PS service, the UE only transmits the ATTACH REQUEST indicating GPRS attach. The UE may only transmit the LOCATION UPDATING REQUEST to the UMTS cell if the UE does not initiate the PS service.

Please note that, the abovementioned steps of the processes including suggested steps can be realized by means that could be hardware, firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include system on chip (SOC), system in package (Sip), computer on module (COM), and the communication device 20.

In conclusion, the exemplary examples and means are provided for handling an attach procedure, so as to avoid that the UE supporting LTE and legacy network cannot attach to any network, causing no service is provided to the UE. In an embodiment, the UE displays a notification to the user for indicating that the attach reject is caused by the APN, and thereby the user can correct the APN setting. In another embodiment, the UE switches from the LTE network to attach the legacy network, so as to obtain services from the legacy network.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of handling attach procedure for a mobile device in a wireless communication system, the method comprising:
performing an attach procedure to a network of the wireless communication system;
receiving an attach reject message of the attach procedure including a reject reason associated to an access point name (APN) setting of the mobile device, from the network; and
displaying a notification message in response to the received attach reject message.

2. The method of claim 1, wherein the notification message indicates the reject reason.

3. The method of claim 1, wherein the reject reason is associated to a wrong APN setting or unknown APN.

4. A method of handling attach procedure for a mobile device in a wireless communication system, the method comprising:
performing a first attach procedure to a first radio access technology (RAT);
receiving an attach reject message of the first attach procedure including a reject reason associated to an access point name (APN) setting of the mobile device, from the first RAT; and
perform a second attach procedure to a second RAT after the attach reject message is received.

5. The method of claim 4, wherein the reject reason is associated to a wrong APN setting or unknown APN.

6. The method of claim 4, wherein performing the second attach procedure to the second RAT after the attach reject message is received comprises:
searching a cell in the second RAT; and
transmitting an attach request message of the second attach procedure to the cell when the cell of the second RAT is found.

7. A communication device of handling attach procedure for a wireless communication system, the communication device comprising:
means for performing a first attach procedure to a first radio access technology (RAT);
means for receiving an attach reject message of the first attach procedure including a reject reason associated to an access point name (APN) setting of the mobile device, from the first RAT; and
means for perform a second attach procedure to a second RAT after the attach reject message is received.

8. The communication device of claim 7, wherein the reject reason is associated to a wrong APN setting or unknown APN.

9. The communication device of claim 7, wherein the means for performing the second attach procedure to the second RAT after the attach reject message is received comprises:
means for searching a cell in the second RAT; and
means for transmitting an attach request message of the second attach procedure to the cell when the cell of the second RAT is found.
